(19) United States
(12) Patent Application Publication
(10) Pub. No.: US 2026/0317499 A1
(43) Pub. Date: Oct. 15, 2026

(54) IMPACT OF CROSS-SECTION ON MECHANICAL PROPERTIES AND LEAK-RESISTANCE OF FOAM

(71) Applicant: Lifoam Industries, LLC, Greer, SC (US)

(72) Inventors: Jonathan Godfrey, Joppa, MD (US); Saumitra Bhargava, Clarksville, MD (US); Sherlock Gillet, Greer, SC (US); Walter Chris Mercy, Felton, PA (US)

(21) Appl. No.: 19/465,603

(22) Filed: Jan. 30, 2026

Related U.S. Application Data
(60) Provisional application No. 63/752,267, filed on Jan. 31, 2025.

(51) Int. Cl. C08J 9/24

(52) U.S. Cl. CPC C08J 9/24; C08J 2367/04

(57) ABSTRACT

A method of making a foam article comprises extruding a polymer formulation through a die comprising a plurality of holes grouped in close proximity to one another. The plurality of holes are positioned such that polymer strands exiting the holes contact and cohere to form a multi-lobal bead having a plurality of interconnected columns. The method further comprises cutting the cohered polymer strands to form individual beads and molding the beads into a foam article. The multi-lobal bead comprises an exterior surface having a first skin thickness and interior interfaces between adjacent columns having a second skin thickness, the second skin thickness being less than the first skin thickness.

### CROSS-REFERENCE TO RELATED APPLICATION

This application claims priority to U.S. Application No. 63/752,267, filed Jan. 31, 2025, which is hereby incorporated by reference in its entirety.

### FIELD OF INVENTION

The present disclosure relates to polymer foam materials and manufacturing methods, and more particularly to multi-lobal bead foam structures produced through multi-hole die configurations that exhibit improved mechanical properties, reduced density, and enhanced leak resistance.

### BACKGROUND

Polymer foam materials have been widely used in various applications including protective packaging, thermal insulation, and cushioning products. Among these materials, bead foam represents a category of cellular foam produced by expanding and molding individual foam particles or beads. Expanded polystyrene (EPS) has long been a dominant material in this field, though environmental considerations have driven interest in alternative materials such as expanded polylactic acid (EPLA) and other biobased polymers.

The production of foam beads typically involves extruding a polymer-blowing agent mixture through a die, followed by pelletizing the extrudate as it exits the die face. The cross-sectional geometry of the die capillaries influences the characteristics of the resulting foam beads, including their shape, skin thickness, and expansion properties. Conventional die designs have employed circular cross-sections, which produce beads with generally spherical or cylindrical shapes after expansion.

Non-circular die cross-sections have been explored as a means to modify bead characteristics. Such approaches have included trilobal, quadra-lobal, and dendritic shaped die holes. However, manufacturing dies with complex non-circular cross-sections directly machined into the die face presents challenges in terms of machining precision and production economics.

The properties of molded foam articles depend on various factors including the characteristics of the individual beads, the manner in which beads fuse together during molding, and the resulting structure of the molded article. Bead skin thickness, cellular architecture, and the interfaces between fused beads all contribute to the mechanical performance of the final article. Additionally, the ability of molded foam articles to resist water penetration is relevant for applications such as coolers and containers designed to hold ice or other liquids.

Biobased polymers such as polylactic acid, polyhydroxyalkanoates (PHA), polybutylene succinate (PBS), and polyhydroxybutyrate (PHB) present particular processing challenges compared to conventional polyolefins. These materials may exhibit enhanced sensitivity to structural deformation and can be prone to collapse during processing, particularly when formed into small-diameter expanded beads.

Accordingly, there remains interest in developing improved foam bead structures and manufacturing approaches that can address various performance characteristics including mechanical properties, density, leak resistance, and processability, particularly for biobased and sustainable polymer materials.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method of making a foam article is provided. The method includes extruding a polymer formulation through a die comprising a plurality of holes, wherein each hole has a diameter of from about 0.2 mm to about 1.0 mm and the plurality of holes are spaced about 0.8 mm to about 3.0 mm center-to-center. The plurality of holes are positioned such that polymer strands exiting the holes contact and cohere to form a multi-lobal bead having a plurality of interconnected columns. The method further includes pelletizing the cohered polymer strands using hot face pelletizing to form individual beads, wherein the polymer strands establish contact along interior edges during the pelletizing. The multi-lobal bead comprises an exterior surface having a first skin thickness and interior interfaces between adjacent columns having a second skin thickness, the second skin thickness being less than the first skin thickness.

The method further includes molding the beads into a foam article using steam chest molding equipment, wherein steam is applied at a pressure of from about 0.2 bar to about 1.0 bar. The foam article can be molded with features having a thickness as thin as about ¼ inch. The foam article can comprise planks having dimensions of up to about 21 inches in length and about 2.25 inches in thickness.

According to other aspects of the present disclosure, the method may include one or more of the following features. The plurality of holes may comprise three holes arranged such that the multi-lobal bead has a trilobal cross-section. The polymer formulation may comprise a polymer selected from the group consisting of polylactic acid, polyhydroxyalkanoates, polybutylene succinate, polyhydroxybutyrate, and combinations thereof. The plurality of holes may comprise holes that are round, oval, or capsule-shaped. The foam article may be leak-resistant without skin-forming additives, coatings, or films. The foam article may have a density of 1.19 to 1.24 pcf and a flexural strength of 24 to 26 psi. The foam article may exhibit reduced shrinkage compared to foam articles produced from beads having a spherical or oval cross-sectional shape.

According to another aspect of the present disclosure, a multi-lobal foam bead is provided. The multi-lobal foam bead includes a plurality of interconnected columns, each column formed from a polymer strand cohered to at least one adjacent polymer strand. The multi-lobal foam bead includes an exterior surface having a first skin thickness. The multi-lobal foam bead includes interior interfaces between adjacent columns having a second skin thickness, the second skin thickness being less than the first skin thickness. The interior interfaces exhibit minimal cellular compression with the cellular architecture remaining largely intact.

According to other aspects of the present disclosure, the multi-lobal foam bead may include one or more of the following features. The bead may have a trilobal cross-section comprising three interconnected columns. The bead may comprise a polymer selected from the group consisting of polylactic acid, polyhydroxyalkanoates, polybutylene succinate, polyhydroxybutyrate, and combinations thereof. The exterior surface may have a membrane thickness of approximately 50 micrometers. The bead may have a density of less than 0.05 g/cm³. The plurality of interconnected columns may define a center void. The bead may be configured to provide acoustic attenuation through multiple internal resonance chambers and tortuous sound paths.

According to another aspect of the present disclosure, a foam article is provided. The foam article includes a plurality of molded multi-lobal beads, each bead comprising a plurality of interconnected columns. Each bead comprises an exterior surface having a first skin thickness and interior interfaces between adjacent columns having a second skin thickness, the second skin thickness being less than the first skin thickness. The foam article is leak-resistant without skin-forming additives, coatings, or films.

According to other aspects of the present disclosure, the foam article may include one or more of the following features. Each bead may have a trilobal cross-section comprising three interconnected columns. The beads may comprise a polymer selected from the group consisting of polylactic acid, polyhydroxyalkanoates, polybutylene succinate, polyhydroxybutyrate, and combinations thereof. The foam article may have a density of 1.19 to 1.24 pcf and a flexural strength of 24 to 26 psi. The foam article may have an R-value of 3.8. The foam article may exhibit a ball drop rebound of approximately 35%.

### BRIEF DESCRIPTION OF FIGURES

Non-limiting and non-exhaustive examples are described with reference to the following figures.

FIG. 1 illustrates optical microscopy images of an expanded polylactic acid bead, according to aspects of the present disclosure.

FIG. 2 illustrates a scanning electron microscopy image of an expanded polylactic acid bead, according to aspects of the present disclosure.

FIG. 3 illustrates a scanning electron microscopy image of an expanded polylactic acid bead at higher magnification, according to aspects of the present disclosure.

FIG. 4 illustrates a scanning electron microscopy image of an expanded polylactic acid bead with a surface anomaly, according to aspects of the present disclosure.

FIG. 5 illustrates a scanning electron microscopy image showing a cross-sectional view of an expanded polylactic acid bead, according to aspects of the present disclosure.

FIG. 6 illustrates a scanning electron microscopy image of an expanded polylactic acid bead showing cellular structure, according to aspects of the present disclosure.

FIG. 7 illustrates a cross-sectional view of multi-lobal beads produced through a tri-hole die configuration, according to aspects of the present disclosure.

FIG. 8 illustrates a microscopic view of multi-lobal beads expanded beside one another, according to aspects of the present disclosure.

FIG. 9 illustrates an optical microscopy image of a multi-lobal bead showing a fusion pattern, according to aspects of the present disclosure.

FIG. 10 illustrates a microscopic cross-sectional view of a multi-lobal bead showing a fusion interface, according to aspects of the present disclosure.

FIG. 11 illustrates an optical microscopy image of tri-hole beads positioned adjacent to one another, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

As used herein, the term “about” or “approximately” when used in conjunction with a numerical value refers to a range that includes the stated value plus or minus 10% of that value.

The present disclosure relates to multi-lobal foam bead structures and foam articles formed therefrom. In some cases, polymer foam materials may be produced through multi-hole die configurations that result in beads having non-circular cross-sections, such as trilobal or other multi-lobal shapes. These multi-lobal foam beads may exhibit improved mechanical properties, reduced density, and enhanced leak resistance compared to conventional foam beads having spherical or oval cross-sections.

Conventional bead foam production typically involves extruding polymer formulations through single circular die holes to produce beads with generally spherical or oval shapes. While such conventional beads have been used in various foam applications, the resulting foam articles may exhibit certain limitations with respect to density, mechanical strength, and resistance to water penetration. In some cases, achieving leak-resistant foam articles using conventional beads may require the addition of skin-forming additives, coatings, or films.

Multi-lobal foam beads as described herein may be produced by extruding polymer formulations through dies having grouped arrangements of multiple small holes positioned in close proximity to one another. As the polymer strands exit the grouped die holes, the strands may contact and cohere along their interior edges to form a unified bead structure comprising multiple interconnected columns. The resulting multi-lobal beads may have a cross-sectional shape that differs from conventional spherical or oval beads.

In some cases, the multi-lobal foam beads may comprise an exterior surface having a first skin thickness and interior interfaces between adjacent columns having a second skin thickness that is less than the first skin thickness. This differential skin thickness architecture may provide various benefits during processing and in the final foam article. The interior interfaces between adjacent columns may exhibit minimal cellular compression, with the cellular architecture remaining largely intact at these interior junctions.

Foam articles formed from multi-lobal beads may exhibit reduced density while maintaining or improving mechanical properties such as flexural strength. In some cases, foam articles formed from multi-lobal beads may be leak-resistant without the use of skin-forming additives, coatings, or films. The multi-lobal bead structure may also provide improved thermal insulation properties, reduced shrinkage, and enhanced cushioning performance compared to foam articles formed from conventional beads.

The multi-lobal foam beads and foam articles described herein may be formed from various polymer materials, including biobased or sustainable polymers. In some cases, the polymer formulation may comprise polylactic acid, polyhydroxyalkanoates, polybutylene succinate, polyhydroxybutyrate, or combinations thereof. The multi-lobal bead architecture may be particularly useful for processing polymers that exhibit enhanced sensitivity to structural deformation compared to conventional polyolefins.

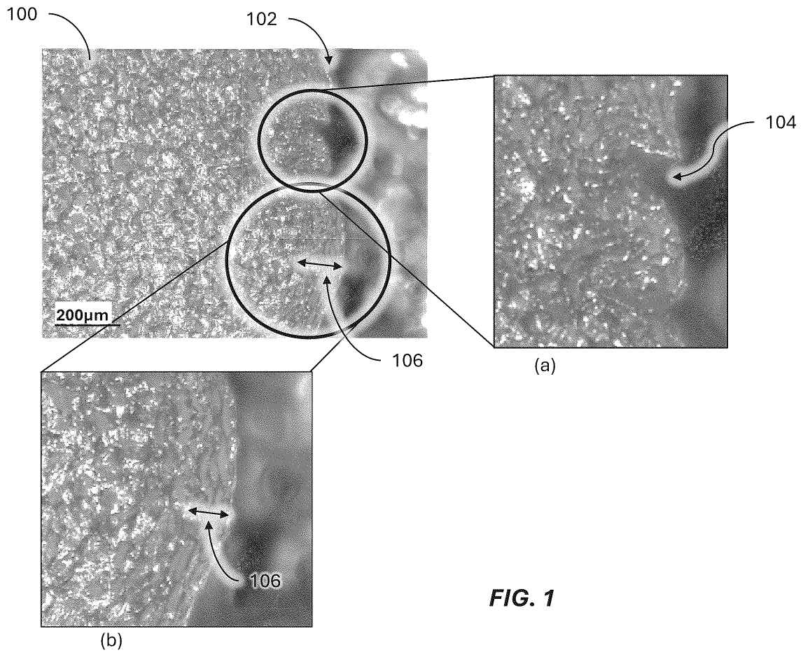

Referring to FIG. 1, optical microscopy analysis of cross-sectioned expanded polylactic acid beads reveals distinct morphological characteristics at magnifications ranging from 50× to 75×. FIG. 1 illustrates an expanded polylactic acid bead 100 designated as “EPLA-4,” which represents a bead exhibiting characteristics suitable for processing and final mechanical performance. The microscopic examination focuses on the peripheral bead skin structure, analyzing both dimensional attributes and morphological configuration of the outer membrane layer.

A membrane boundary 102 is visible along the peripheral edge of the expanded polylactic acid bead 100, forming the outer skin of the bead structure. The membrane boundary 102 demarcates the transition between the exterior surface and the internal cellular architecture of the expanded polylactic acid bead 100. The membrane boundary 102 may have a thickness of approximately 50 micrometers around the exterior surface of the expanded polylactic acid bead 100.

With continued reference to FIG. 1, a surface anomaly 104 is indicated by a circled region in the upper portion of the main image and is shown in greater detail in the magnified inset labeled (a). The surface anomaly 104 is characterized by irregular membrane formation manifesting as a surface depression with approximate depths of 50 micrometers. The surface anomaly 104 exhibits atypical cellular dimensions and non-uniform membrane thickness. Specimens exhibiting substantial surface depressions may demonstrate reduced thermal stability during molding operations and diminished structural integrity under applied pressure. Surface depressions not exceeding 75 micrometers in depth may be within acceptable parameters, particularly when presenting as narrow, valley-like or triangular conformations.

A compressed cellular structure 106 is indicated by arrows in both the main image and the magnified inset labeled (b) of FIG. 1. The compressed cellular structure 106 demonstrates compressive deformation of cellular structures adjacent to the membrane boundary 102 and lateral boundaries. The degree of cellular compression within the compressed cellular structure 106 serves as a quantitative indicator of overall bead structural integrity and manufacturing quality. The magnified inset (b) provides a detailed view of the compressed cellular structure 106 near the membrane-sidewall interface, showing progressive cellular wall deformation extending multiple cellular units inward from the peripheral boundary. The compressed cellular structure 106 exhibits spherical morphology in core regions, transitioning to pronounced compression within approximately 50 to 100 micrometers of the membrane boundary 102.

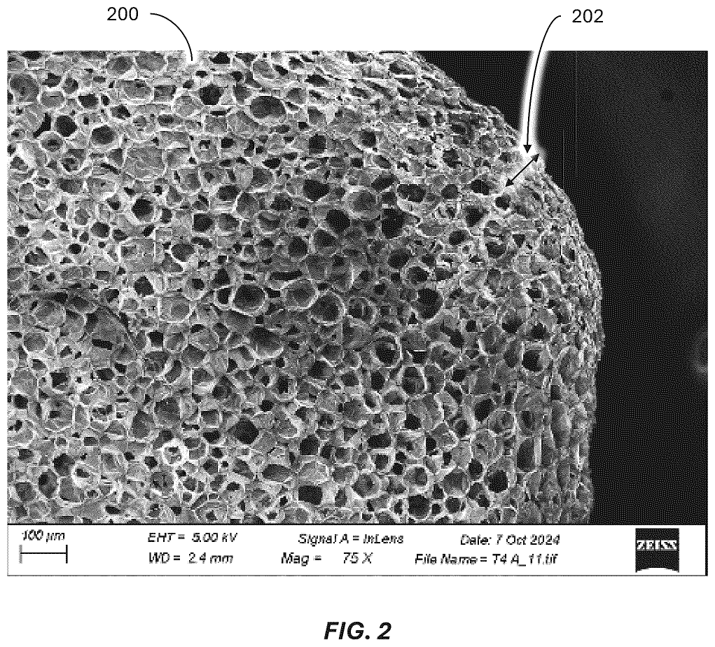

Referring to FIG. 2, scanning electron microscopy (SEM) analysis provides higher resolution documentation of cellular structures within expanded polylactic acid beads. FIG. 2 illustrates an expanded polylactic acid bead 200, also of the type designated as “EPLA-4.” Expanded polylactic acid bead 200 is depicted at 75× magnification, revealing the cellular foam structure characteristic of expanded polylactic acid materials. A membrane boundary 202 is visible along the exterior surface of the expanded polylactic acid bead 200, forming the outer skin of the bead structure. The membrane boundary 202 demarcates the transition between the exterior surface and the internal cellular architecture of the expanded polylactic acid bead 200. The internal structure of the expanded polylactic acid bead 200 exhibits a porous cellular morphology with cells that appear spherical in the core regions. The cellular structures adjacent to the membrane boundary 202 show some degree of compression, with cells transitioning from spherical shapes in the interior to more compressed configurations near the peripheral boundary.

With continued reference to FIG. 2, the membrane boundary 202 maintains a relatively uniform thickness around the exterior surface of the expanded polylactic acid bead 200. The SEM imaging provides detailed documentation of the cellular wall architecture and the relationship between the membrane boundary 202 and the underlying cellular foam structure.

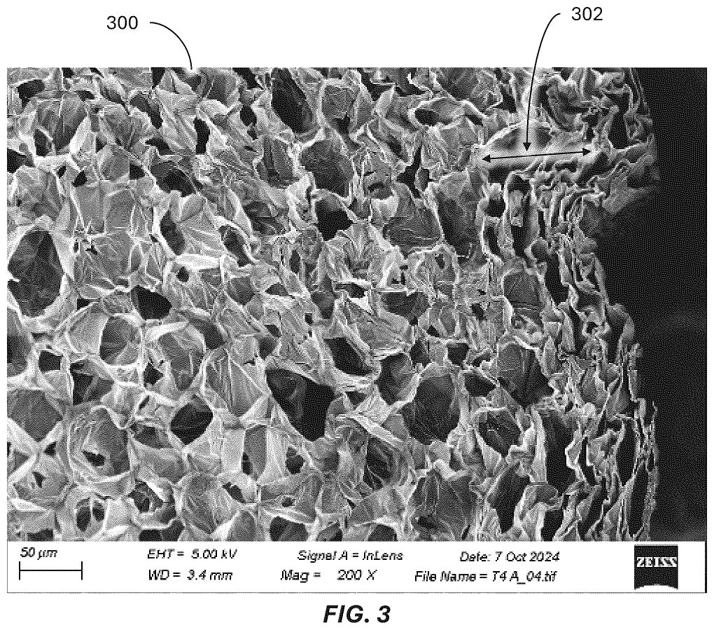

Referring to FIG. 3, an expanded polylactic acid bead 300, also of the type designated as “EPLA-4,” is shown at 200× magnification. The SEM image provides a detailed view of the cellular structure and membrane characteristics of the expanded polylactic acid bead 300. The expanded polylactic acid bead 300 exhibits a porous cellular architecture with interconnected cell walls forming a foam structure. A membrane boundary 302 is visible along the exterior surface of the expanded polylactic acid bead 300, demarcating the transition between the outer skin layer and the internal cellular structure. The cellular structures adjacent to the membrane boundary 302 display compressive deformation, with cells appearing flattened near the peripheral boundary. The internal cellular structure exhibits spherical morphology in the core regions, transitioning to pronounced compression within approximately 50 to 100 micrometers of the membrane boundary 302. A scale bar indicating 50 micrometers is provided for dimensional reference.

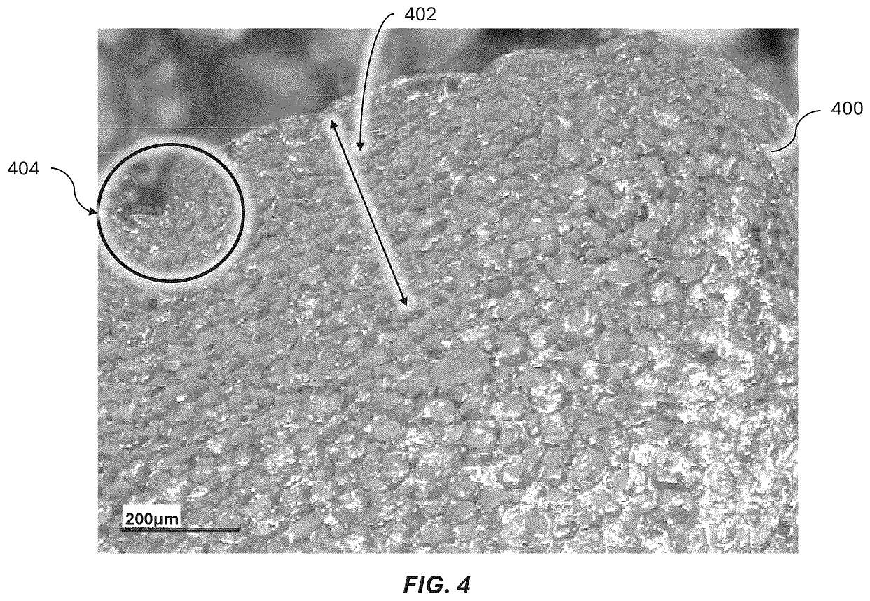

Referring to FIG. 4, an expanded polylactic acid bead 400 is shown at 200× magnification. The expanded polylactic acid bead 400 represents a specimen designated as “EPLA-1,” which exhibited processing challenges during formation into final parts, in contrast to the polylactic acid beads in FIGS. 1-3, of the type designated as “EPLA-4,” which exhibit characteristics suitable for processing and final mechanical performance. The expanded polylactic acid bead 400 displays a cellular foam structure with visible spherical and compressed cells throughout the cross-section. A membrane boundary 402 is indicated along the outer peripheral surface of the expanded polylactic acid bead 400, representing the outer membrane layer that forms during the extrusion and expansion process. The membrane boundary 402 defines the interface between the bead exterior and the internal cellular architecture.

With continued reference to FIG. 4, a surface anomaly 404 is highlighted by a circular region on the left side of the image, indicating an area of irregular membrane formation. The surface anomaly 404 manifests as a surface depression characteristic of atypical cellular dimensions and non-uniform membrane thickness. Such surface anomalies may be associated with reduced thermal stability during molding operations and diminished structural integrity under applied pressure. The cellular structures adjacent to the membrane boundary 402 exhibit compressive deformation, with the degree of cellular compression serving as an indicator of overall bead structural integrity and manufacturing quality. The internal cellular structure transitions from spherical morphology in core regions to pronounced compression within approximately 50 to 100 micrometers of the membrane boundary 402.

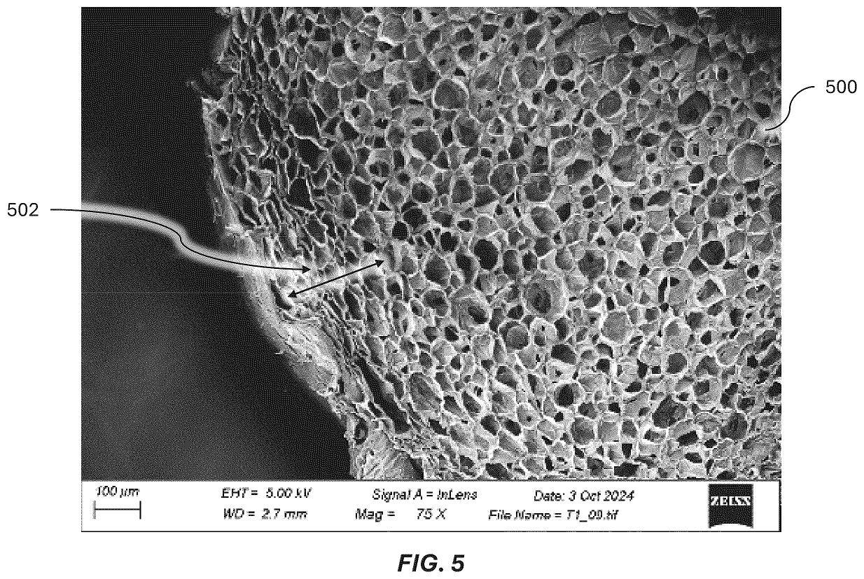

Referring to FIG. 5, an expanded polylactic acid bead 500, also of the type designated as “EPLA-1,” is shown at 75× magnification. The expanded polylactic acid bead 500 exhibits a cellular foam structure characterized by numerous interconnected cells of varying sizes distributed throughout the interior of the bead. The cellular architecture displays spherical morphology in the core regions of the expanded polylactic acid bead 500. A membrane boundary 502 is visible along the left edge of the expanded polylactic acid bead 500, demarcating the outer surface of the bead from the internal cellular structure. The membrane boundary 502 appears as a relatively dense layer compared to the porous interior. Adjacent to the membrane boundary 502, the cellular structures exhibit compressive deformation, with cells appearing flattened or elongated compared to the more spherical cells located deeper within the bead interior. This transition zone extends approximately 50 to 100 micrometers inward from the membrane boundary 502.

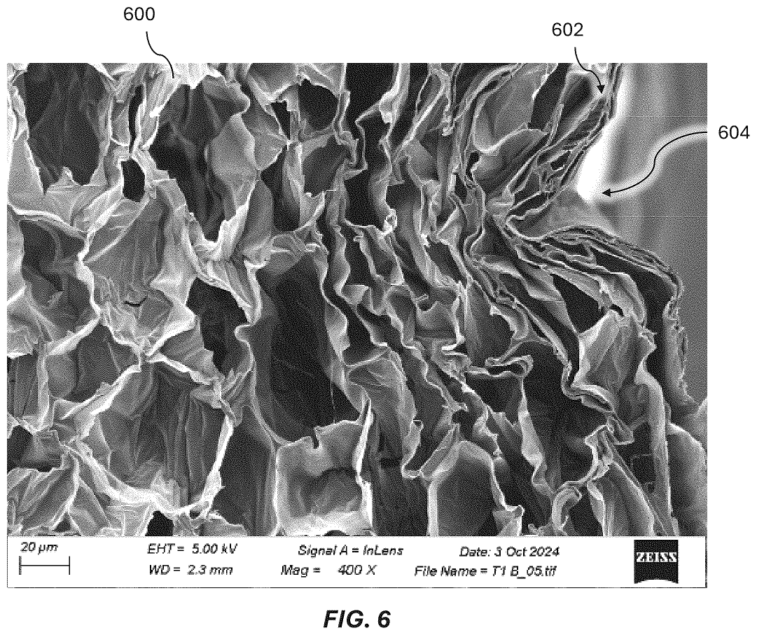

Referring to FIG. 6, an expanded polylactic acid bead 600, also of the type designated as “EPLA-1,” is shown at 400× magnification. The expanded polylactic acid bead 600 exhibits a cellular foam structure characterized by layered, sheet-like cellular walls with multiple folded and crumpled surfaces throughout the bead material. A membrane boundary 602 is indicated in the upper right portion of the image, representing a region where adjacent polymer strands have cohered during the extrusion process. The membrane boundary 602 demonstrates the junction between interconnected columns of the expanded polylactic acid bead 600, where the skin thickness may be relatively thin compared to exterior surfaces. A surface anomaly 604 is visible along the right edge of the image, showing the exterior surface of the expanded polylactic acid bead 600 where a thicker skin layer forms. The cellular architecture throughout the expanded polylactic acid bead 600 displays irregular folding patterns and varying degrees of compression characteristic of expanded polylactic acid foam.

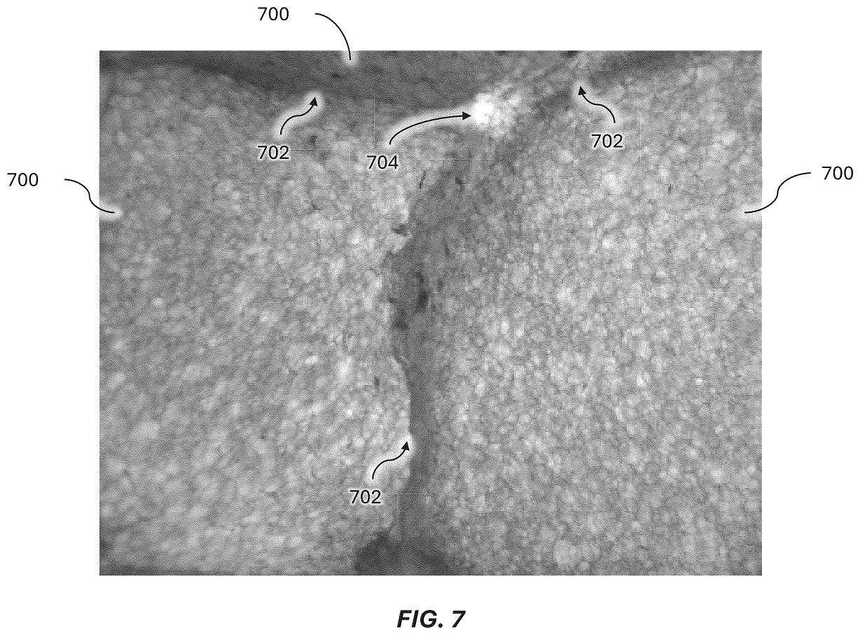

Referring to FIG. 7, a multi-lobal bead 700 is shown in cross-sectional view. The multi-lobal bead 700 is produced through a multi-hole die configuration wherein a polymer formulation is extruded through a die comprising a plurality of holes positioned such that polymer strands exiting the holes contact and cohere to form the multi-lobal bead 700 having a plurality of interconnected columns. As described in U.S. Pat. App. Pub. No. 2016/0325472 to Lifoam Industries LLC, non-circular cross-sections for extruded polylactic acid bead foam have been contemplated, including trilobal, quadra-lobal, and dendritic shapes. However, dies based on such configurations may be difficult to machine or uneconomical to produce. The multi-hole die configuration described herein provides an alternative and unexpectedly advantageous approach wherein multiple small holes are grouped closely together such that, as the bead foam exits the die, the extrusion results in cohesion of bead interfaces creating a multi-lobal bead shape.

With continued reference to FIG. 7, each hole in the die may have a diameter of from about 0.2 mm to about 1.0 mm, and the plurality of holes may be spaced about 0.8 mm to about 3.0 mm center-to-center. The plurality of holes may comprise holes that are round, oval, or capsule-shaped. In some cases, the holes may have a preferred aspect ratio of 1.5:1 to 2.0:1, with a maximum practical aspect ratio of 4:1 for structural integrity under repeated high-pressure cycling. The inter-orifice ligament, defined as the edge-to-edge spacing between holes, may range from 0.2 mm minimum to 1.8 mm maximum. The 0.2 mm minimum inter-orifice ligament may be required for die structural integrity under pressure. In one example, an inter-orifice ligament of 0.90 mm was achieved from 1.30 mm center-to-center spacing with 0.40 mm diameter orifices.

The number of holes per group in the die configuration may range from 3 to 6 holes. Configurations beyond 6 holes may cause material flow issues, complicated die design, and challenging processing windows against temperature and pressure variations. At 2.00 mm center-to-center spacing with 0.80 mm diameter orifices, which corresponds to a 1.20 mm ligament, approximately 70% trilobal formation may be achieved. The coalescence rate may decrease as orifice diameter increases. At 0.2 mm diameter holes, nearly 100% trilobal formation may be expected, while near 1 mm diameter, only 10-30% trilobal formation may be expected.

As further shown in FIG. 7, the multi-lobal bead 700 displays bonding patterns characterized by a skin 702 at multiple locations including between the individual strands that form the multi-lobal bead 700 and on the exterior surfaces of the multi-lobal bead 700. The multi-lobal bead 700 comprises an exterior surface having a first skin thickness and interior interfaces between adjacent columns having a second skin thickness, the second skin thickness being less than the first skin thickness. The skin 702 between individual strands within the multi-lobal bead 700 may be relatively thin compared to exterior surfaces. A gap 704 is visible in the central region where the three strands forming the multi-lobal bead 700 did not fully contact during the extrusion and cooling process. The gap 704 represents an area where the polymer strands exiting the grouped die holes failed to cohere completely.

In some cases, the multi-lobal bead 700 may be produced using air cooling, where beads exit the die and are cooled with air. The cross-sectional view of FIG. 7 demonstrates the internal architecture of the multi-lobal bead 700, showing how the strands join together while maintaining distinct columnar structures within the multi-lobal bead 700.

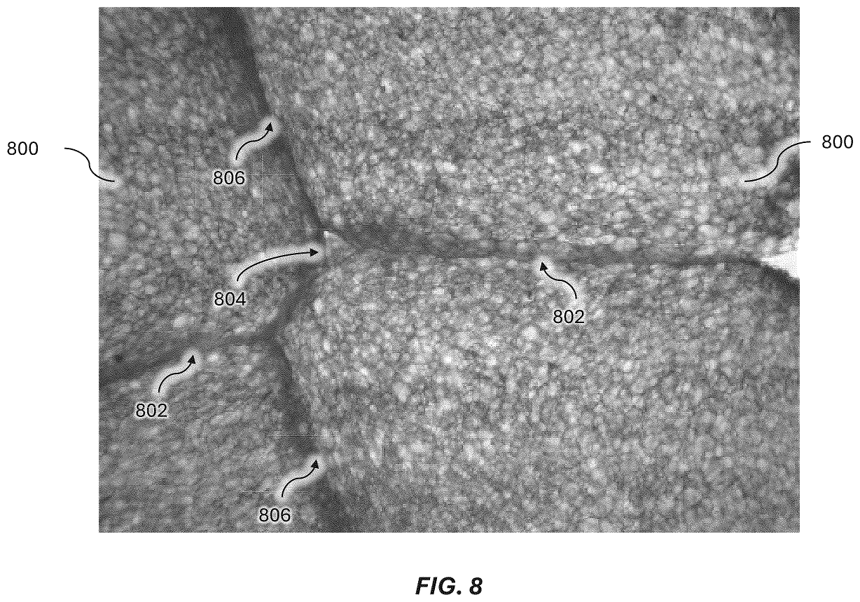

Referring to FIG. 8, a microscopic view illustrates two multi-lobal beads 800 expanded beside one another. The multi-lobal beads 800 demonstrate the structural arrangement that occurs when tri-hole beads are positioned adjacent to each other during the molding process. Multiple instances of a thin skin 802 are visible throughout the image, representing the membrane regions that form between the individual strands within each multi-lobal bead 800 as well as the thicker skin 806 that develop when the multi-lobal beads 800 fuse to one another during steam chest molding. The image demonstrates the difference in skin thickness between the internal strand interfaces and the external fusion zones between adjacent beads.

With continued reference to FIG. 8, a gap 804 is present at the location where the multi-lobal beads 800 intersect. The gaps 804 represent voids that may appear between the curved surfaces of the tri-hole bead structures. The gaps 804 where the three strands did not touch create additional voids that appear between where round tri-hole beads intersect. The multi-lobal beads 800 exhibit a granular cellular structure characteristic of expanded polylactic acid foam, with the cellular architecture visible throughout each bead.

The molding process for forming foam articles from multi-lobal beads may involve molding the beads into a foam article using steam at a pressure of 0.2 bar to 1.0 bar. The steam pressure for molding may have an optimal range of 0.7 to 1.0 bar for faster sintering cycle time. The minimum steam pressure of 0.2 bar may be based on the glass transition temperature of polylactic acid. The header pressure for tri-hole trials may be 40-50 psi, with typical steam chest molding range being 40-80 psi. Conventional molding of expanded polylactic acid as described in U.S. Pat. No. 10,688,698 to Lifoam Industries LLC and U.S. Pat. App. Pub. No. 2022/0315723 to Lifoam Industries LLC showed limited steaming time, particularly in relation to direct steaming time, with steaming pressures that were lower than those achieved with multi-lobal beads. During molding of the tri-hole bead foam, molding pressures may be higher than conventional, with beads molding into articles at 0.8 bar to 0.9 bar of steam pressure.

As further shown in FIG. 8, the thin skin 802 provides evidence of how the shape of the multi-lobal beads 800 influences the packing arrangement and the formation of both thin skin regions 802 between internal strands and thicker skin regions 806 at bead-to-bead fusion interfaces. The optimal ratio of trilobal to individual beads may be 80-90% trilobal beads, where individual beads assist in filling and flow while trilobal beads pack more efficiently but flow slightly slower. Not all tri-hole die groupings may produce beads which form a single trilobal bead, and in some cases the grouping of three die holes may produce three independent beads. The mixture of trilobal grouped beads and smaller individual beads may aid in improved mechanical properties of the resulting foam article.

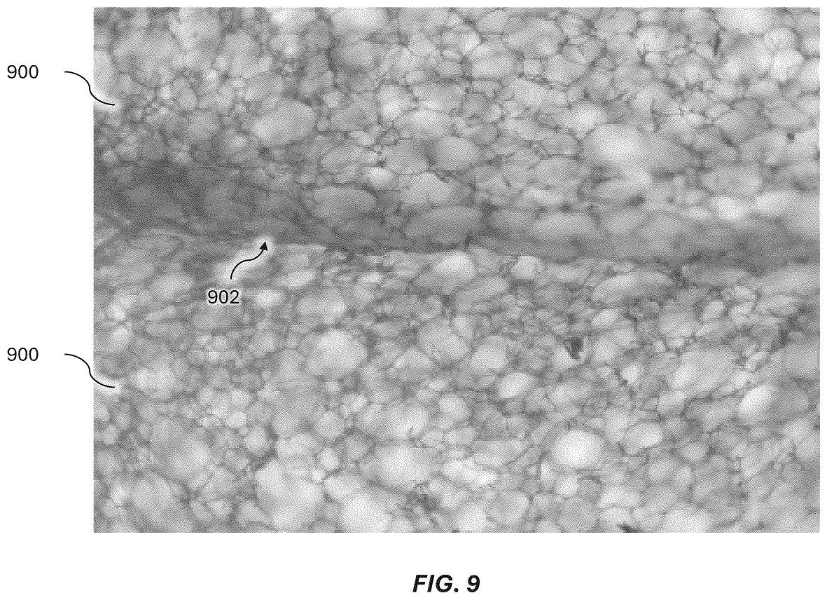

Referring to FIG. 9, a multi-lobal bead 900 is shown in cross-sectional view illustrating the fusion characteristics between polymer strands. Two regions of the multi-lobal bead 900 are visible in the image, positioned above and below a central interface region. A jagged fusion pattern 902 is present at the interface where the strands exited the die and cooled, forming permanent bonds between the strands. The jagged fusion pattern 902 demonstrates the geometric bonding characteristics that occur between adjacent strands during the bead formation process. The cellular structure of the multi-lobal bead 900 is visible throughout the image, showing the foam architecture within each strand region.

With continued reference to FIG. 9, the jagged fusion pattern 902 exhibits irregular geometric contours along the interface between adjacent columns of the multi-lobal bead 900. The geometric patterns of the jagged fusion pattern 902 may provide strong bonds between adjacent strands within the multi-lobal bead 900 structure. As the polymer strands exit the grouped die holes and contact one another, the strands may interlock along the jagged fusion pattern 902 during cooling, resulting in permanent bonds that resist separation under applied stress.

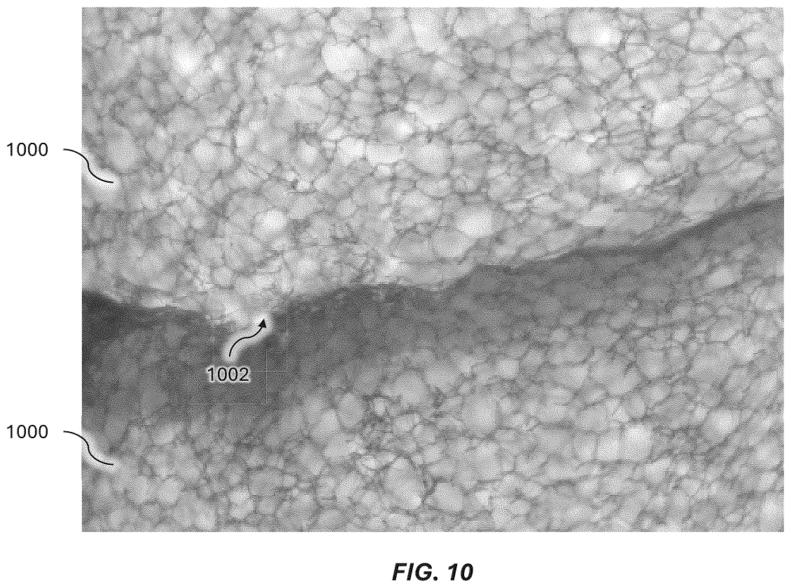

Referring to FIG. 10, a multi-lobal bead 1000 is shown in microscopic cross-sectional view illustrating the fusion interface between interconnected columns. The multi-lobal bead 1000 exhibits a cellular foam structure with visible cell walls throughout the bead material. A jagged fusion pattern 1002 is visible at the interface where two polymer strands have cohered during the extrusion process, forming a permanent bond between adjacent columns of the multi-lobal bead 1000. The jagged fusion pattern 1002 demonstrates the irregular geometric bonding that occurs as the strands exit the die and cool, with the fusion interface extending across the junction between the interconnected columns of the multi-lobal bead 1000.

As further shown in FIG. 10, the jagged fusion pattern 1002 exhibits geometric patterns similar to the jagged fusion pattern 902 of the multi-lobal bead 900 shown in FIG. 9. The geometric patterns of the jagged fusion pattern 1002 may provide strong bonds between adjacent strands within the multi-lobal bead 1000 structure. The irregular contours along the jagged fusion pattern 1002 may increase the surface area of contact between adjacent columns, thereby enhancing the bond strength at the fusion interface. The permanent bonds formed along the jagged fusion pattern 1002 may contribute to the structural integrity of the multi-lobal bead 1000 during subsequent processing and molding operations.

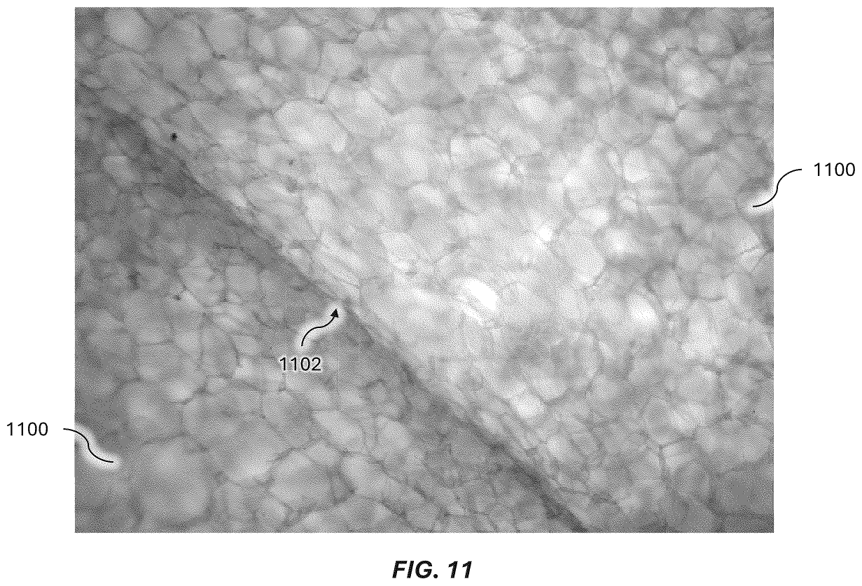

Referring to FIG. 11, two tri-hole beads 1100 are shown positioned adjacent to one another. The tri-hole beads 1100 are shown with sufficient spacing between the beads such that a thin skin region 1102 is formed where the adjoining surfaces of the strands meet. The thin skin region 1102 is barely identifiable between the strands, demonstrating how the tri-hole beads 1100 may bond and cool without forming a thick outer skin when adequate space exists between the beads.

With continued reference to FIG. 11, the thin skin region 1102 illustrates the differential skin thickness architecture of the multi-lobal bead structure. The interior interfaces between adjacent columns, as represented by the thin skin region 1102, have a second skin thickness that is less than the first skin thickness of exterior surfaces. When the tri-hole beads 1100 bond and cool with enough space between the beads, the adjoining surfaces of the strands remain very light, with the skin between the beads being hardly identifiable between the strands. This characteristic demonstrates that the interior interfaces between adjacent columns within the multi-lobal bead structure may exhibit minimal membrane formation compared to the thicker membrane that forms on exterior surfaces exposed to the cooling environment.

A multi-lobal foam bead may comprise a plurality of interconnected columns, each column formed from a polymer strand cohered to at least one adjacent polymer strand. The multi-lobal foam bead may comprise an exterior surface having a first skin thickness and interior interfaces between adjacent columns having a second skin thickness, the second skin thickness being less than the first skin thickness. The interior interfaces may exhibit minimal cellular compression with the cellular architecture remaining largely intact at the junctions between adjacent columns.

In some cases, the multi-lobal foam bead may have a trilobal cross-section comprising three interconnected columns. The trilobal cross-section may be formed when three polymer strands exit grouped die holes and cohere along their interior edges during the extrusion and pelletizing process. In other cases, the multi-lobal foam bead may be formed with holes organized in various patterns such as four holes exiting beside one another or five holes organized as a final cross shape. The number of interconnected columns in the multi-lobal foam bead may correspond to the number of holes in the grouped die configuration.

The multi-lobal foam bead may comprise a polymer selected from the group consisting of polylactic acid, polyhydroxyalkanoates, polybutylene succinate, polyhydroxybutyrate, and combinations thereof. In some cases, the foam article may be made from materials including expanded polybutylene succinate (PBS), expanded polybutylene adipate terephthalate (PBAT), expanded polyhydroxyalkanoates (PHA), and expanded polystyrene (EPS) in addition to expanded polylactic acid (EPLA). The multi-lobal bead architecture may be useful for processing biobased or sustainable polymers that exhibit enhanced sensitivity to structural deformation compared to conventional polyolefins.

The exterior surface of the multi-lobal foam bead may have a membrane thickness of approximately 50 micrometers. The membrane thickness at the exterior surface may be greater than the membrane thickness at the interior interfaces between adjacent columns. The differential membrane thickness between the exterior surface and the interior interfaces may result from the different cooling conditions experienced by exterior surfaces exposed to the cooling environment compared to interior surfaces where adjacent polymer strands contact and cohere.

In some cases, the multi-lobal foam bead may have a density of less than 0.05 g/cm³.

The multi-lobal bead architecture may enable achievement of reduced bulk densities compared to conventional single-strand bead formations. The plurality of interconnected columns may define a center void within the multi-lobal foam bead. The center void may be formed when the polymer strands exiting the grouped die holes do not fully contact in the central region during the extrusion and cooling process. The center void may provide additional benefits including acoustic attenuation through multiple internal resonance chambers and tortuous sound paths.

The multi-lobal foam bead may be configured to provide acoustic attenuation through multiple internal resonance chambers and tortuous sound paths. The acoustic attenuation properties of the multi-lobal foam bead may result from several mechanisms associated with the multi-column architecture and the internal void structures formed during the extrusion and coalescence process.

Helmholtz resonance may occur within the internal void structures of the multi-lobal foam bead. The center void and gaps formed where polymer strands do not fully contact during extrusion may function as resonance chambers that absorb sound energy at specific frequencies. The dimensions and geometry of the internal void structures may influence the resonant frequencies at which acoustic energy is attenuated.

Sound path tortuosity may result from the complex internal geometry of the multi-lobal foam bead. The interconnected columns and the interfaces between adjacent columns may create non-linear pathways through which sound waves travel. As sound waves encounter the multiple interfaces and void structures within the multi-lobal foam bead, the sound waves may be redirected along tortuous paths that increase the effective distance traveled and the opportunities for energy dissipation.

Variable cross-sectional effects within the multi-lobal foam bead may create interference patterns that contribute to acoustic attenuation. The differential skin thickness between exterior surfaces and interior interfaces, combined with the varying cell sizes and geometries throughout the bead structure, may cause sound waves to interact in ways that produce destructive interference at certain frequencies.

Multiple resonance chambers may be formed at coalescence interfaces where adjacent polymer strands cohere during the extrusion process. The jagged fusion patterns at these coalescence interfaces may create irregular geometries that function as additional resonance chambers. The combination of the center void, the gaps between strands, and the irregular geometries at fusion interfaces may provide a plurality of resonance chambers distributed throughout the multi-lobal foam bead structure.

Expanded polypropylene (EPP) foam cylinders with center holes have been used commercially for acoustic attenuation applications. The center void in such EPP foam cylinders creates a tortuous path for sound to travel, thereby enhancing acoustic attenuation compared to solid foam structures. The multi-lobal foam bead architecture described herein may provide acoustic attenuation through mechanisms that extend beyond those of simple center-hole configurations. The multi-lobal foam bead may combine Helmholtz resonance, tortuosity, interference patterns, center void space, and variable cross-sectional effects to provide acoustic attenuation performance. The multiple interconnected columns and the plurality of internal void structures within the multi-lobal foam bead may create a more complex acoustic environment compared to single-hole foam configurations.

The method of making a foam article may comprise pelletizing the cohered polymer strands using hot face pelletizing to form individual beads. Hot face pelletizing involves cutting the polymer strands at the die face while the polymer material remains in a heated, softened state. During hot face pelletizing, the polymer strands establish contact along interior edges during the pelletizing process. The contact between adjacent polymer strands at the die face allows the strands to cohere and form a unified multi-lobal bead structure before the bead material cools and solidifies.

In the hot face pelletizing process, a cutting mechanism positioned at the die face severs the extruded polymer strands at regular intervals to form discrete bead units. The timing and speed of the cutting mechanism may be adjusted to control the length and size of the resulting beads. As the polymer strands exit the grouped die holes and are cut by the pelletizing mechanism, the strands may contact one another along their interior edges while still in a softened state. The contact between adjacent strands during the pelletizing process allows the strands to bond together, forming the interconnected columnar structure characteristic of multi-lobal beads.

Following hot face pelletizing, the beads may be cooled using an air cooling method where beads exit the die and are cooled with air. Air cooling allows the multi-lobal bead structure to solidify while maintaining the cohered configuration established during the pelletizing process. The air cooling method may provide sufficient cooling to preserve the multi-lobal bead geometry without causing excessive thermal shock that could damage the bead structure.

In some cases, the multi-lobal bead may be produced using underwater pelletizing at lower pressure and higher temperatures to sustain low density while allowing individual bead strands to join. Underwater pelletizing involves cutting the polymer strands in a water bath that provides rapid cooling of the bead material. When using underwater pelletizing for multi-lobal bead production, the process parameters may be adjusted to operate at lower pressure and higher temperatures compared to conventional underwater pelletizing conditions. The lower pressure may help sustain the low density of the foam bead structure by reducing compression of the cellular architecture during the pelletizing process. The higher temperatures may maintain the polymer strands in a sufficiently softened state to allow the individual bead strands to join and cohere along their interior edges before the water bath cools and solidifies the bead structure.

The trilobal formation success rate may depend on the relationship between hole spacing and hole diameter in the die configuration. In some cases, the plurality of holes comprises three holes arranged such that the multi-lobal bead has a trilobal cross-section. At 2.00 mm center-to-center spacing with 0.80 mm diameter orifices, which corresponds to a 1.20 mm inter-orifice ligament, approximately 70% trilobal formation may be achieved. As orifice diameter increases, the coalescence rate may decrease. Near 1 mm diameter orifices, only 10-30% trilobal formation may be expected. At 0.2 mm diameter orifices, nearly 100% trilobal formation may be expected.

The relationship between hole size and coalescence may be attributed to the behavior of the polymer strands as the strands exit the die and contact one another. Smaller diameter holes produce smaller polymer strands that cool more rapidly and have greater reliance on surface skin to support the bead structure. The smaller strands may more readily cohere along their interior edges during the pelletizing process due to the higher surface area to volume ratio and the shorter distance over which the strands contact one another. Larger diameter holes produce larger polymer strands that rely more on internal nucleation for structural support and may have reduced tendency to cohere with adjacent strands.

The method of making a foam article may utilize a polymer formulation comprising a polymer selected from the group consisting of polylactic acid, polyhydroxyalkanoates, polybutylene succinate, polyhydroxybutyrate, and combinations thereof. The hot face pelletizing process may be applied to these polymer formulations to produce multi-lobal beads having the interconnected columnar structure described herein. The tri-hole die configuration with smaller diameter holes may more easily allow the polymer strands to join out of the die by means of hot face pelletizing, as the smaller strands may cohere more readily during the pelletizing process.

A foam article may comprise a plurality of molded multi-lobal beads. Each bead in the foam article may comprise a plurality of interconnected columns. Each bead may comprise an exterior surface having a first skin thickness and interior interfaces between adjacent columns having a second skin thickness. The second skin thickness may be less than the first skin thickness. The differential skin thickness architecture of the multi-lobal beads may contribute to the structural and functional properties of the foam article.

In some cases, each bead in the foam article may have a trilobal cross-section comprising three interconnected columns. The trilobal cross-section may result from the extrusion of polymer strands through a tri-hole die configuration where three closely spaced holes allow the polymer strands to cohere during the extrusion and pelletizing process. In other cases, the multi-lobal beads may have cross-sections comprising four, five, six, or more interconnected columns depending on the number of holes in the grouped die configuration.

The beads in the foam article may comprise a polymer selected from the group consisting of polylactic acid, polyhydroxyalkanoates, polybutylene succinate, polyhydroxybutyrate, and combinations thereof. The multi-lobal bead architecture may be applied to various biobased or sustainable polymer formulations to produce foam articles having improved properties compared to foam articles formed from conventional spherical or oval beads.

The foam article may be leak-resistant without skin-forming additives, coatings, or films. Conventional approaches to achieving leak-resistant foam articles may involve the application of petroleum-based bead foam or coating, or the use of a film or skin to ensure leak-proofing. The foam article formed from multi-lobal beads may achieve leak resistance through the structural characteristics of the multi-lobal bead architecture rather than through the addition of skin-forming materials, coatings, or films applied to the foam article surface.

The leak resistance of the foam article may result from the packing arrangement of the multi-lobal beads during the molding process. Despite having a multi-lobal shape that might be expected to have issues with packing density, foam articles formed from multi-lobal beads may exhibit very little open area. Open area refers to the empty dead space between beads in a molded foam article. The multi-lobal beads may expand and entangle during the molding process to fill in more open area than conventional cellular foams having spherical or oval bead shapes. The reduced open area in the foam article may contribute to the leak resistance by reducing the pathways through which water or other fluids could penetrate the foam structure.

The differential skin thickness architecture of the multi-lobal beads may also contribute to the leak resistance of the foam article. The exterior surfaces of the multi-lobal beads having the first skin thickness may provide a barrier against fluid penetration at the outer surfaces of the foam article. The interior interfaces between adjacent columns having the second skin thickness may allow for improved fusion between beads during the steam chest molding process. The combination of the exterior skin barrier and the improved inter-bead fusion may result in a foam article that resists water penetration without the need for additional skin-forming additives, coatings, or films.

Leak resistance of foam articles formed from multi-lobal beads may be evaluated using a leak test methodology. The leak test may involve filling a glass jar with 0.5 liter of water and placing the glass jar upside down on a foam board formed from the multi-lobal beads. The foam board may be checked at intervals to determine if any water has leaked through to the other side of the foam article. The checking intervals may include 10 minutes, 30 minutes, 1 hour, 2 hours, 4 hours, 8 hours, 24 hours, and 72 hours after placement of the water-filled jar on the foam board.

In testing of foam articles formed from multi-lobal beads produced through a tri-hole die configuration, the foam articles did not allow any water to penetrate to the other side during each check at the specified intervals up to 72 hours. In contrast, foam articles formed from conventional beads produced through a standard die configuration may allow water to penetrate within 30 seconds. The extended leak resistance of foam articles formed from multi-lobal beads demonstrates the improved barrier properties achieved through the multi-lobal bead architecture without the use of skin-forming additives, coatings, or films.

The leak-resistant properties of the foam article may be useful for applications such as coolers that hold water, including ice that has melted. Such applications may be referred to as “leak-free” coolers. The foam article formed from multi-lobal beads may provide leak-free performance without the need for additional materials or processing steps that would otherwise be required to achieve leak resistance in foam articles formed from conventional beads.

The foam article formed from multi-lobal beads may exhibit mechanical and thermal properties that differ from foam articles formed from conventional beads having spherical or oval cross-sectional shapes. The foam article may have a density of 1.19 to 1.24 pcf and a flexural strength of 24 to 26 psi. The density of the foam article formed from multi-lobal beads may be 20-30% lower than the density of foam articles formed from conventional beads while maintaining comparable flexural strength. The ability to reduce density without changing flexural strength may be attributed to the multi-lobal bead architecture and the improved contact surface area between beads during the molding process.

The foam article may have a bending modulus of 127 to 132 psi. In comparison, foam articles formed from conventional beads produced through a standard die configuration may have a bending modulus of 175 to 250 psi. The lower bending modulus of the foam article formed from multi-lobal beads may indicate a well fused and highly flexible material. The reduced bending modulus may result from the improved fusion between multi-lobal beads during the steam chest molding process and the differential skin thickness architecture of the multi-lobal beads.

Flexural strength testing of the foam article may be conducted in accordance with ASTM C203. The ASTM C203 standard provides a test method for determining the flexural properties of cellular materials. The flexural strength of 24 to 26 psi achieved by the foam article formed from multi-lobal beads may be comparable to the flexural strength of foam articles formed from conventional beads having higher density, demonstrating that the multi-lobal bead architecture may enable maintenance of mechanical strength at reduced density.

The foam article may have an R-value of 3.8. The R-value represents the thermal resistance of the foam article and may be expressed as R-value per inch. R-value testing may be conducted using FOX heat flow meters in accordance with ASTM C518, ISO 8301, or DIN EN 12667. The foam test articles used for R-value testing may be 2.125 inches thick. The R-value of 3.8 achieved by the foam article formed from multi-lobal beads may match the R-value of foam articles formed from conventional beads at higher density, as well as the R-value of expanded polystyrene at a density of 1.2 pcf. The maintenance of thermal insulation performance at reduced density may be attributed to the cellular architecture and the packing arrangement of the multi-lobal beads in the foam article.

The foam article may exhibit a ball drop rebound of approximately 35%. The ball drop rebound test may be conducted using a steel ball having a weight of 64 grams dropped from a height of 1.5 meters. The ball drop rebound measurement represents the percentage return from the original 1.5 meter drop height. In comparison, foam articles formed from conventional beads produced through a standard die configuration may exhibit a ball drop rebound of approximately 20%. The increased ball drop rebound of the foam article formed from multi-lobal beads may indicate improved cushioning performance compared to foam articles formed from conventional beads.

The foam article may have a surface smoothness characterized by a root mean square (RMS) roughness of 19 microinches (pin). In comparison, foam articles formed from conventional beads produced through a standard die configuration may have a surface smoothness RMS of 40 pin. The improved surface smoothness of the foam article formed from multi-lobal beads may result from the packing arrangement of the multi-lobal beads and the reduced open area between beads in the molded foam article. The smoother surface finish may be beneficial for applications where surface quality affects the appearance or functional performance of the foam article.

The foam article formed from multi-lobal beads may exhibit reduced shrinkage compared to foam articles produced from beads having a spherical or oval cross-sectional shape. Shrinkage refers to the dimensional change that occurs in a molded foam article as the article cools and stabilizes following the molding process. The shrinkage of a foam article may be expressed as a percentage of the mold dimensions, representing the difference between the mold cavity dimensions and the final dimensions of the molded foam article after stabilization.

Foam articles formed from multi-lobal beads produced through a tri-hole die configuration may exhibit shrinkage of approximately 1.0% versus mold dimensions. In comparison, foam articles formed from standard expanded polylactic acid beads produced through conventional die configurations may exhibit shrinkage of approximately 1.5% versus mold dimensions. The difference between 1.5% shrinkage for standard expanded polylactic acid and 1.0% shrinkage for tri-hole expanded polylactic acid represents a 30% reduction in shrinkage achieved through the multi-lobal bead architecture.

The reduced shrinkage of foam articles formed from multi-lobal beads may be illustrated by dimensional examples. A foam article molded in a 12 inch by 12 inch mold cavity using standard expanded polylactic acid beads may have final dimensions of approximately 11.82 inches after stabilization, reflecting the 1.5% shrinkage. A foam article molded in the same 12 inch by 12 inch mold cavity using tri-hole expanded polylactic acid beads may have final dimensions of approximately 11.88 inches after stabilization, reflecting the 1.0% shrinkage. The 1.0% shrinkage exhibited by foam articles formed from multi-lobal beads may match the shrinkage rate of expanded polystyrene, which exhibits shrinkage of 0.9-1.0%.

The reduced shrinkage of foam articles formed from multi-lobal beads may be attributed to the increased mechanical strength provided by the thick skin portions within the multi-lobal bead structure. The differential skin thickness architecture of the multi-lobal beads, wherein the exterior surfaces have a first skin thickness greater than the second skin thickness at interior interfaces between adjacent columns, may provide structural reinforcement that resists dimensional change during the cooling and stabilization process.

The reduced shrinkage may provide benefits for various applications of the foam article. Reduced shrinkage may be beneficial for automation processes where consistent dimensional tolerances are required for handling and processing of foam articles. Reduced shrinkage may also be beneficial for pack-out designs with engineered gel packs where clearances between the foam article and other components affect the performance of the packaging system. The reduced space for component movement resulting from lower shrinkage may reduce vibration and compounding damage during shipping and handling.

The stabilization time for foam articles formed from expanded polylactic acid beads may be approximately 1 hour after molding. During the stabilization period, the foam article undergoes dimensional changes as the cellular structure equilibrates with the surrounding environment and residual stresses from the molding process relax. The shrinkage measurements described herein may be taken after the stabilization period has elapsed.

The multi-lobal bead may have an extruded density that is lower than the extruded density of beads produced through conventional round hole die configurations. Multi-lobal beads produced through a tri-hole die configuration may have an extruded density of approximately 1.05 lb/ft³, which may be calculated either through directly measuring the density of a bead or by measuring the density of a known volume of beads. In comparison, beads produced through a conventional round hole die configuration may have an extruded density of approximately 1.30 1b/ft³. The difference between 1.30 lb/ft³ for round hole beads and 1.05 lb/ft³ for tri-hole beads represents approximately 20% lower extruded density achieved through the multi-lobal bead architecture.

The foam article formed from multi-lobal beads may have a molded density that is lower than the molded density of foam articles formed from beads produced through conventional round hole die configurations. Foam articles formed from multi-lobal beads may have a molded density of approximately 1.2 lb/ft³, measured by determining the weight of the part in pounds and dividing by the measured dimensional volume. In comparison, foam articles formed from beads produced through a conventional round hole die configuration may have a molded density of approximately 1.55 lb/ft³. The molded density of 1.2 lb/ft³ for foam articles formed from multi-lobal beads falls within the range of 1.19 to 1.24 pcf described herein.

The reduction in both extruded density and molded density achieved through the multi-lobal bead architecture may be attributed to the geometry of the multi-lobal beads and the manner in which the beads expand and pack during the molding process. Despite having a multi-lobal shape that might be expected to have issues with packing density, the multi-lobal beads may expand and entangle during the molding process in a manner that achieves low density while maintaining structural integrity and mechanical properties. The foam article may have a density of 1.19 to 1.24 pcf and a flexural strength of 24 to 26 psi, demonstrating that the reduced density does not compromise the mechanical performance of the foam article.

In a method of making a foam article, the foam article may exhibit reduced shrinkage compared to foam articles produced from beads having a spherical or oval cross-sectional shape. The method may produce a foam article that is leak-resistant without skin-forming additives, coatings, or films while achieving the reduced shrinkage and density characteristics described herein.

The foam articles formed from multi-lobal beads may be characterized using various testing and measurement methodologies to evaluate the structural and performance properties of the foam material.

Open area measurement may be performed to quantify the empty dead space between beads in a cross-section of the molded foam article. The open area measurement method may involve shading the surface of a cross-section of the foam article with a marker to create contrast between the solid bead material and the void spaces between beads. ImageJ software may be used to analyze the colored surface of the cross-section. The analysis process may comprise converting the image to 8-bit grayscale, setting a threshold to separate dark regions from light regions, and measuring the area fraction of each region. The dark regions may correspond to the marker-shaded solid bead material, while the light regions may correspond to the void spaces between beads. The percentage of dark versus light surface area calculated through this method provides a quantitative measurement of the open area in the foam article cross-section.

The ball drop rebound test may be used to evaluate the cushioning performance of the foam article. The ball drop rebound test may be conducted using a steel ball having a weight of 64 grams. The steel ball may be dropped from a height of 1.5 meters onto the surface of the foam article. The measurement recorded from the ball drop rebound test represents the percentage return from the original 1.5 meter drop height. The rebound percentage provides an indication of the energy absorption and return characteristics of the foam material, which may correlate with cushioning performance in protective packaging applications.

The molding process for foam articles formed from multi-lobal beads may exhibit reduced heating time compared to foam articles formed from beads produced through standard die configurations. The total heating time during molding may be 12 seconds for tri-hole beads compared to 14 seconds for standard die configuration. The reduced heating time for tri-hole beads may be attributed to the improved packing arrangement of the multi-lobal beads and the differential skin thickness architecture that allows for efficient heat transfer and fusion during the steam chest molding process. The reduced heating time may provide benefits for manufacturing efficiency by enabling shorter cycle times in the molding process.

### Example 1

Two test runs were conducted using a tri-hole shaped die to produce beads having a trilobal shape. Not all tri-hole groupings produced trilobal shapes, with some of the groupings producing small individual beads rather than cohered multi-lobal structures. The first test run involves producing beads using the process described in U.S. Pat. No. 10,688,698 to Lifoam Industries LLC (the '698 Patent), and producing beads using the process described in U.S. Pat. App. Pub. No. 2022/0315723 to Lifoam Industries LLC (the '723 App) except using a die with a tri-hole configuration to produce beads. The second test run produced beads using the processes described in the '698 Patent and '723 App except using a die with a tri-hole configuration to produce beads with no chain extender present in the polymer formulation.

During molding of the tri-hole bead foam, molding pressures were higher than those achieved with conventional expanded polylactic acid molding. The first set of beads molded into articles at 0.8 bar of steam pressure, and the second set of beads molded into articles at 0.9 bar of steam pressure. Conventional molding of expanded polylactic acid as defined by the '698 Patent showed limited steaming time, particularly in relation to direct steaming time, with steaming pressures that were lower than those achieved with the tri-hole beads. The direct steaming time for the tri-hole beads was higher given that a higher pressure needed to be achieved. The improved packing of the tri-hole beads compared to oval or spherical shapes may have limited the flow of steam through the article, contributing to the higher pressures achieved. The shape of the beads and the placement of thicker skins in the bead mass may provide enhanced heat resistance and better stability during heating.

Table 1 below provides a comparison of the tri-hole expanded polylactic acid process with previous expanded polylactic acid molding process applications.

TABLE 1
Comparison of Tri-hole EPLA Process with Previous Processes

| | ′698 Patent | ′723 App | Inventive |
|---|---|---|---|
| Step | Process | Process | Process |
| Steam Before Time (sec) | 3 | 0 | 0 |
| Fill Time (sec) | 3 | 2.5 | 2.5 |
| Hydraulic Time (sec) | 7.8 | 7.8 | 7.8 |
| Direct Steaming Time (sec) | 1.2 | 1.2 | 5 |
| Venting Time (sec) | 2 | 1.2 | 1 |
| Stabilization Time (sec) | 15 | 7 | 13 |
| Total Time (sec) | 32 | 19.7 | 29.3 |
| Maximum Molding Pressure (bar) | 0.1 | 0.2 | 0.9 |
| Total Steaming Time (sec) | 4.2 | 1.2 | 5.0 |
| Max Temperature (°F) | 98.7 | 96.0 | 107.0 |
| Min Temperature (°F) | 81.1 | 86.0 | 90.0 |
| Temperature Delta (°F) | 17.6 | 10.0 | 17.0 |

Table 2 below provides a comparison of the tri-hole expanded polylactic acid process with a conventional expanded polystyrene (EPS) molding process.

TABLE 2
Comparison of Tri-hole EPLA Process
with Conventional EPS Process

| | Conventional | Inventive Process |
|---|---|---|
| Step | EPS Process | with Trihole Bead |
| Steam Before Time (sec) | 0 | 0 |
| Fill Time (sec) | 2.5 | 2.5 |
| Hydraulic Time (sec) | 7.8 | 7.8 |
| Direct Steaming Time (sec) | 5.5 | 5 |
| Venting Time (sec) | 1 | 1 |
| Cooling Water Time (sec) | 0.2 | 0 |
| Stabilization Time (sec) | 15 | 13 |
| Total Time (sec) | 32 | 29.3 |
| Maximum Molding Pressure (bar) | 1.0 | 0.9 |
| Total Steaming Time (sec) | 5.5 | 5.0 |
| Max Temperature (°F) | 110.0 | 107.0 |
| Min Temperature (°F) | 85.0 | 90.0 |
| Temperature Delta (°F) | 25.0 | 17.0 |

Articles from both test runs were tested for water leaks by filling a glass jar with 0.5 liter of water and placing the jar on the foam board upside down. After 10 minutes, 30 minutes, 1 hour, 2 hours, 4 hours, 8 hours, 24 hours, and 72 hours, the articles were checked to determine if any water had leaked through the other side of the foam article. During each check, the articles did not allow any water to penetrate to the other side.

Articles were tested from both test runs for flexural strength in accordance with ASTM C203. Both articles exhibited the same flexural strength as standard formulation expanded polylactic acid produced in oval shapes in the '723 App. However, the density was 20-30% lower than the standard formulation. A flexural strength of 24-26 psi was achieved while maintaining a density of 1.19 to 1.24 pcf. The bending modulus of the material was 127 to 132 psi, compared to the standard material having a bending modulus of 175 to 250 psi. The lower bending modulus suggests a well fused and highly flexible material.

Heat flow testing was conducted on both test runs, and an R-value of 3.8 was recorded for both materials despite being 20-30% lower in density than the standard formulation. The standard formulation produced in oval shapes in the '723 App has an R-value of 3.8. Expanded polystyrene at a density of 1.2 pcf also has an R-value of 3.8. The foam articles formed from tri-hole beads matched the R-value of previous denser runs while also achieving an R-value that matches petroleum-based expanded polystyrene at equivalent density.

Table 3 below provides a comparison of foam articles formed from standard die configuration beads and tri-hole die configuration beads.

TABLE 3
Comparison of Standard Die and Tri-Hole Die

| | Standard | Tri-Hole |
|---|---|---|
| | Die/Standard | Die/Standard |
| Parameter | Formulation | Formulation |
| Peak Steam Pressure during | 0.3 | 0.8 |
| molding (bar) | | |
| Total Heating Time (seconds) | 14 | 12 |
| Leak Test Duration | 30 seconds | 72+ hours |
| Extruded Density (lb/ft³) | 1.3 | 1.05 |
| Molded Density (lb/ft³) | 1.55 | 1.24 |
| Flexural Strength (psi) | 25 | 24 |
| Bending Modulus (psi) | 250 | 132 |
| R-Value (ft² · °F · h/BTU) | 3.8 | 3.8 |
| Surface Smoothness - RMS (μin) | 40 | 19 |
| Ball Drop Rebound | 20% | 35% |

A number of implementations have been described. Nevertheless, it will be understood that various modifications may be made without departing from the spirit and scope of the disclosure. Accordingly, other implementations are within the scope of the following claims.

1. A method of making a foam article comprising:
extruding a polymer formulation through a die comprising a plurality of holes, wherein each hole has a diameter of from about 0.2 mm to about 1.0 mm and the plurality of holes are spaced about 0.8 mm to about 3.0 mm center-to-center, and wherein the plurality of holes are positioned such that polymer strands exiting the holes contact and cohere to form a multi-lobal bead having a plurality of interconnected columns;
pelletizing the cohered polymer strands using hot face pelletizing to form individual beads, wherein the polymer strands establish contact along interior edges during the pelletizing; and
molding the beads into a foam article using steam at a pressure of about 0.2 bar to about 1.0 bar,
wherein the multi-lobal bead comprises an exterior surface having a first skin thickness and interior interfaces between adjacent columns having a second skin thickness, the second skin thickness being less than the first skin thickness.

2. The method of claim 1, wherein the plurality of holes comprises three holes arranged such that the multi-lobal bead has a trilobal cross-section.

3. The method of claim 1, wherein the polymer formulation comprises a polymer selected from the group consisting of polylactic acid, polyhydroxyalkanoates, polybutylene succinate, polyhydroxybutyrate, and combinations thereof.

4. The method of claim 1, wherein the plurality of holes comprises holes that are round, oval, or capsule-shaped.

5. The method of claim 1, wherein the foam article is leak-resistant without skin-forming additives, coatings, or films.

6. The method of claim 1, wherein the foam article has a density of 1.19 to 1.24 pcf and a flexural strength of 24 to 26 psi.

7. The method of claim 1, wherein the foam article exhibits reduced shrinkage compared to foam articles produced from beads having a spherical or oval cross-sectional shape.

8. A multi-lobal foam bead comprising:
a plurality of interconnected columns, each column formed from a polymer strand cohered to at least one adjacent polymer strand;
an exterior surface having a first skin thickness; and
interior interfaces between adjacent columns having a second skin thickness, the second skin thickness being less than the first skin thickness,
wherein the interior interfaces exhibit minimal cellular compression with the cellular architecture remaining largely intact.

9. The multi-lobal foam bead of claim 8, wherein the bead has a trilobal cross-section comprising three interconnected columns.

10. The multi-lobal foam bead of claim 8, wherein the bead comprises a polymer selected from the group consisting of polylactic acid, polyhydroxyalkanoates, polybutylene succinate, polyhydroxybutyrate, and combinations thereof.

11. The multi-lobal foam bead of claim 8, wherein the exterior surface has a membrane thickness of approximately 50 micrometers.

12. The multi-lobal foam bead of claim 8, wherein the bead has a density of less than 0.05 g/cm³.

13. The multi-lobal foam bead of claim 8, wherein the plurality of interconnected columns define a center void.

14. The multi-lobal foam bead of claim 8, wherein the bead is configured to provide acoustic attenuation through multiple internal resonance chambers and tortuous sound paths.

15. A foam article comprising:
a plurality of molded multi-lobal beads, each bead comprising a plurality of interconnected columns, wherein each bead comprises an exterior surface having a first skin thickness and interior interfaces between adjacent columns having a second skin thickness, the second skin thickness being less than the first skin thickness,
wherein the foam article is leak-resistant without skin-forming additives, coatings, or films.

16. The foam article of claim 15, wherein each bead has a trilobal cross-section comprising three interconnected columns.

17. The foam article of claim 15, wherein the beads comprise a polymer selected from the group consisting of polylactic acid, polyhydroxyalkanoates, polybutylene succinate, polyhydroxybutyrate, and combinations thereof.

18. The foam article of claim 15, wherein the foam article has a density of 1.19 to 1.24 pcf and a flexural strength of 24 to 26 psi.

19. The foam article of claim 15, wherein the foam article has an R-value of 3.8.

20. The foam article of claim 15, wherein the foam article exhibits a ball drop rebound of approximately 35%.
